(19) United States
(12) Patent Application Publication
(10) Pub. No.: US 2007/0299999 A1
(43) Pub. Date: Dec. 27, 2007

(54) Link protocol control for serial protocols

(76) Inventors: Vicky Duerk, Shrewsbury, MA (US); Pak-Lung Seto, Shrewbury, MA (US)

Correspondence Address: INTEL CORPORATION;c/o INTELLEVATE, LLC, P.O. BOX 52050, MINNEAPOLIS, MN, 55402, US

(21) Appl. No.: 11/472,917

(22) Filed: Jun. 21, 2006

(51) Int. Cl. G06F 13/42

(52) U.S. Cl. 710/105; 709/230

(57) ABSTRACT

A state machine encoded in state machine instructions is stored in non-volatile memory, and loaded into volatile memory in a hardware engine for use by the hardware engine upon power up or reset. Storing the state machine for a phy reset sequence in non-volatile memory coupled to the hardware engine allows protocol modifications to the state machine to be performed in the non-volatile memory.

### FIELD

This disclosure relates to serial protocols and in particular to link/loop initialization.

### BACKGROUND

Storage communication architectures such as the Serial Attached Small Computer System Interface (SAS) and Serial Advanced Technology Attachment (SATA) include a phy layer that defines an encoding scheme for transferring data. The phy layer performs a phy reset sequence after power on or reset to initialize a SAS/SATA link and make the link operational. The phy reset sequence includes an Out of Band (OOB) sequence and a speed negotiation sequence.

In both SAS and SATA architectures, the phy reset sequence may be implemented in either firmware or hardware. The advantage of implementing the phy reset sequence in firmware is flexibility because modifications may be made to firmware without any hardware modification. The disadvantage of this approach is that it is latency sensitive, especially in a multi-tasking environment, because it requires that firmware handshakes with hardware to perform most tasks. The advantage of implementing the phy reset sequence in hardware is that it is low in latency. However, the disadvantage is that after it is hard coded in hardware, any modification requires a new version of the hardware.

### BRIEF DESCRIPTION OF THE DRAWINGS

Features of embodiments of the claimed subject matter will become apparent as the following detailed description proceeds, and upon reference to the drawings, in which like numerals depict like parts, and in which:

FIG. 1 is a block diagram of an embodiment of a hardware engine that includes a microsequencer and volatile memory;

FIG. 2 is a state machine diagram that illustrates OOB sequence states in the phy reset sequence;

FIG. 3 is a block diagram of an embodiment of the hardware engine 100 shown in FIG. 1; and

FIG. 4 is a state machine diagram that illustrates SAS speed negotiation states in the phy reset sequence.

Although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly, and be defined only as set forth in the accompanying claims.

### DETAILED DESCRIPTION

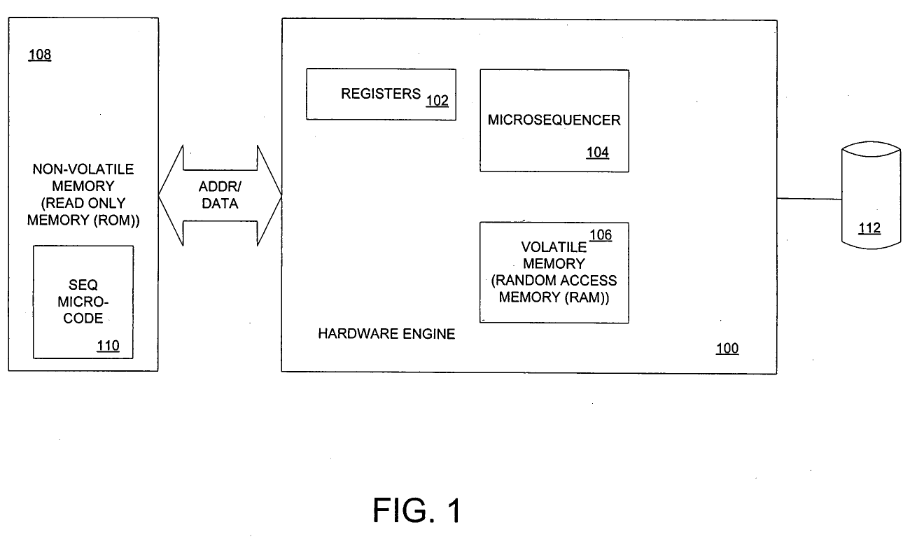

FIG. 1 is a block diagram of an embodiment of a hardware engine 100 that includes a microsequencer 104, volatile memory 106 and registers 102. The microsequencer generates memory addresses used to step through microcode stored in a memory. Instead of implementing a phy reset sequence in firmware or hard coding the phy reset sequence in the hardware engine 100, the phy reset sequence is implemented as sequencer microcode which is stored in non-volatile memory 108 coupled to the hardware engine 100. The sequencer microcode may also be stored in a magnetic media such as a hard disk drive. The sequencer microcode includes state machine instructions which will be discussed later.

The non-volatile memory 108 may be any type of non-volatile memory, for example, Read Only Memory (ROM), Programmable Read Only memory (PROM) or Flash memory. The volatile memory 106 may be Dynamic Random Access Memory (DRAM), Static Random Access Memory (SRAM), Synchronized Dynamic Random Access Memory (SDRAM) or Rambus Dynamic Random Access Memory (RDRAM). In an embodiment, the volatile memory 106 is an on-chip Random Access Memory (RAM) that may be loaded during power-up from the non-volatile memory 108.

On power-up or reset, the sequencer microcode is read from non-volatile memory 108 or loaded by some external circuit and stored in volatile memory 106 in the hardware engine 100. After the sequencer microcode is stored in volatile memory 106 in the hardware engine 100, it may be accessed by the microsequencer 104. Latency is reduced by storing the sequencer microcode in the volatile memory in the hardware engine 100. Furthermore, because the sequencer microcode 110 is stored in external non-volatile memory 108 prior to loading it into the volatile memory 106 in the hardware engine 100, the sequencer microcode 110 may be easily modified by storing a new version of the sequencer microcode 110 in the non-volatile memory 108. Thus, a modification of the sequencer microcode 110 does not require replacing a hardcoded hardware engine 100.

In an embodiment, the hardware engine 100 performs phy layer functions encoded in the sequencer microcode for one or more storage devices 112 coupled to a serial storage bus. The storage device may be a disk drive, Digital Video Disk (DVD) drive, compact disk (CD) drive, Redundant Array of Independent Disks (RAID), or tape drive.

There are many serial storage protocol suites such as, Serial Attached Small Computer System Interface (SAS) and Serial Advanced Technology Attachment (SATA). A version of the SATA protocol is described in “Serial ATA: High Speed Serialized AT Attachment,” Revision 1.0a, published on Jan. 7, 2003 by the Serial ATA Working Group (hereinafter termed the “SATA standard”). A version of the SAS protocol is described in “Information Technology—Serial Attached SCSI—1.1,” Working Draft American National Standard of International Committee For Information Technology Standards (INCITS) T10 Technical Committee, Project T10/1562-D, Revision 1, published Sep. 18, 2003, by ANSI (hereinafter termed the “SAS Standard”).

An embodiment of the invention will be described for the SAS protocol. The SAS protocol architecture defines six layers: physical, phy, link, port, transport and application. The phy layer defines an encoding scheme in which information (data and control) is encoded into 10-bit characters using 8b/10b encoding. In 8b/10b encoding, eight bits are encoded at a time into a 10-bit character and then transmitted serially bit-by-bit across the physical link. Eight information bits and a control variable (value D-data, value K-control) is encoded into the 10-bit character.

The 8-bit characters are grouped into four 8-bit character sequences that are referred to as dwords. A primitive is a dword whose first character is a control character. For example, the ALIGN primitive used by the phy layer is a dword whose first 8-bit character is the K28.5 control character.

Phy layer functions include link level reset, initialization and speed negotiation which are performed using a phy reset sequence and a speed negotiation sequence. A phy reset sequence is originated by the SAS phy layer upon power on, a hard reset or upon a request from a management application layer. The phy reset sequence includes an Out of Band (OOB) sequence and a speed negotiation sequence. The speed negotiation sequence begins after the OOB sequence is complete.

The OOB sequence includes a plurality of OOB signals which are signal patterns that do not appear in normal data streams. An OOB signal includes idle time followed by burst time. During the idle time, the physical link carries D.C. idle and during the burst time, the physical link carries signal transitions.

To transmit an OOB signal, a transmitter device sends the following sequence six times; (1) transmit D.C. idle for an idle time and (2) transmit an OOB burst of ALIGN primitives for a burst time. D.C. idle is a differential signal level that is about 0 Volts (peak-to-peak) used during the idle time of an OOB signal. An OOB signal is defined based on the length of the D.C. idle time between the OOB bursts of ALIGN primitives. SAS defines the COMINIT and COMSAS OOB signals. Sequencer microcode 110 that includes instructions for the OOB sequence may be stored in the non-volatile memory 108 and copied to the volatile memory 106 in the hardware engine 100.

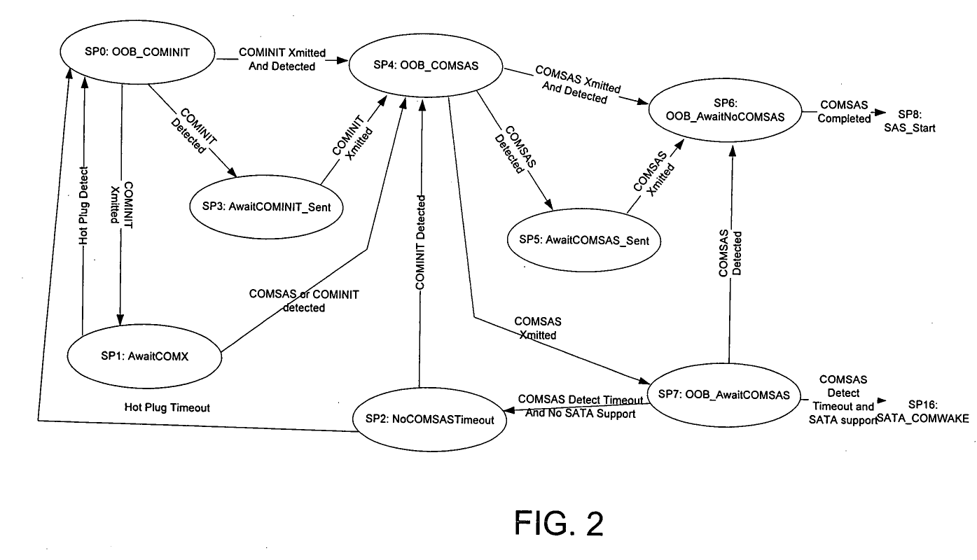

FIG. 2 is a state machine diagram that illustrates OOB sequence states in the phy reset sequence. FIG. 2 will be described in conjunction with FIG. 1. The OOB sequence in the phy reset sequence for a SAS initiator/target includes an exchange of COMINIT OOB signals between the initiator and the target followed by an exchange of COMSAS OOB signals. In the OOB sequence for a SATA host/device, a device responds with a COMINIT OOB signal in response to a COMRESET OOB signal received from a host. The host and device then exchange COMWAKE OOB signals.

In an embodiment of the invention, the OOB sequence states in the OOB state machine shown in FIG. 2 are implemented in sequencer microcode that includes state machine instructions. For example, a state machine instruction may be used to set certain status bits in the registers 102 (FIG. 1), wait for certain conditions to happen and then branch to another address (another state), or check the values of a combination of bits and execute some predefined subroutines. Upon power on, a hard reset or a request from a management application layer, in one embodiment the sequencer microcode is copied to volatile memory 106 in the hardware engine 100 from the non-volatile memory 108. In another embodiment, the sequencer microcode is accessed directly from non-volatile memory by the sequencer if the access time to non-volatile memory is sufficient to allow direct access.

The OOB sequence manages the exchange of OOB signals over a link between an initiator and a target. The OOB sequence states are labeled SP0-SP7 with OOB sequence state SP0 being the initial state of the OOB sequence state machine. In state SP0, the state machine waits for receipt of a COMINIT transmitted message and/or a COMINIT detected message. A state transition to state SP1 occurs if a COMINIT transmitted message is received and a COMINIT detected message has not been received. A state transition to state SP3 occurs if a COMINIIT detected message is received and a COMINIT transmitted message has not been received. A state transition to state SP4 occurs if both a COMINIT transmitted message and a COMINIT detected message have been received.

An example of state machine instructions for implementing state SP0 according to an embodiment of the present invention are as follows:

SP0: OUT (transmit COMINIT, stop DWS, phy layer not ready)
SP0_wait: WAIT (COMINIT transmitted, COMINIT detected)

| COMINIT transmitted, | COMINIT detected | |
|---|---|---|
| 1 | 0 | SP1 |
| 0 | 1 | SP3 |
| 1 | 1 | SP4 |
| Default | | SP0_wait |

The OUT state machine instruction results in setting one or more outputs. In an embodiment, the outputs correspond to SAS primitives such as ALIGN and SAS signals such as COMINIT, COMSAS and COMWAKE. The outputs may also be defined by general classes “transmit” and “stop/start”.

In an embodiment, the transmit class may include but is not limited to the following outputs:
Transmit COMINIT
Transmit COMSAS
Transmit COMWAKE
Transmit D10.2
Transmit D.C. idle
Transmit ALIGN(0)
Transmit ALIGN(1)
Transmit SATA Port selection signal

In an embodiment, the start/stop class may include but is not limited to the following outputs:
start DWS
stop DWS
start await ALIGN timeout timer
start hot-plug timeout timer
start COMSAS detect timeout timer

The outputs listed above may be stored in registers (storage elements) 102 for use by other states. Upon entry into state SP0, a stop DWS message is sent to a SP_DWS state machine and a Phy Layer Not Ready confirmation is sent to the link layer. In the OUT state machine instruction for state SP0, “transmit COMINIT” results in the COMINIT signal being transmitted, and “stop DWS” and “phy layer not ready” result in respective messages being sent. Other classes in addition to stop/start and transmit may be created dependent on the serial storage protocols supported.

The WAIT state machine instruction acts like a case statement. The inputs “COMINIT transmitted”, and “COMINIT detected” are input branching conditions and the states SP1, SP3, SP4 are addresses of respective states of the state machine. The default state is for state SP0 to re-run the WAIT state machine instruction.

In an embodiment, the input branching conditions in the WAIT instruction may include but is not limited to those shown below:
COMINIT transmitted
COMINIT detected
COMSAS transmitted
COMSAS detected
COMSAS completed
COMWAKE transmitted
COMWAKE detected
COMWAKE completed
SATA port selection signal transmitted
Hot-plug timeout timer expired
COMSAS detect timeout timer expires
MgmtReset
Current SN window rate is supported
ALIGN(0) received (with physical link rate argument in SATA)
ALIGN(1) received
Dword received
DWS lost
DWS reset

Many of the input conditions shown above are dependent on the state of the OOB sequence signals COMINIT, COMSAS, COMWAKE. The state of the OOB sequence is determined through respective transmitted, detected and completed messages. Other input conditions include dword received, dword synchronization (DWS) lost and dword synchronization (DWS) reset. The receipt of the ALIGN primitive and the expiration of timers such as the hot-plug timer and COMSAS detect timeout timer may also be used for input branching conditions. In this embodiment, inputs (branching conditions) are not driven by the state machine that is programmed in the volatile memory 106.

State SP1 includes an OUT and a WAIT state machine instruction. Upon entry to state SP1, a hot-plug timer is initialized and started if the phy is an expander phy, an initiator phy or a target phy implementing the hot-plug timeout timer. A state transition to state SP4 occurs if a COMINIT or COMSAS message is detected before the hot-plug timer expires. A state transition to state SP0 occurs, if the hot-plug timeout timer expires prior to detecting a COMINIT or COMSAS message. In an embodiment, the state machine instructions for state SP1 are shown below as an example:

SP1: OUT (start hot-plug timeout timer)
SP1_wait: WAIT (hot-plug timer expires, COMINIT detected,
COMSAS detected)

| Hot-plug timeout | COMINIT | COMSAS. | |
|---|---|---|---|
| 1 | x | x | SP0 |
| 0 | 0 | 1 | SP4 |
| 0 | 1 | 0 | SP4 |
| 0 | 1 | 1 | SP4 |
| 0 | 0 | 0 | SP1_wait |

The OUT state machine instruction is followed by a WAIT state machine instruction. COMINIT transmitted message, hot-plug timeout expires, COMSAS message detected are inputs to the WAIT state machine instruction and the states SP0, and SP4 are addresses of different states of the state machine. The default state is for state SP1 to re-run the WAIT instruction.

Upon entry to state SP2, the hot-plug timer is initialized and started if the phy is an expander phy or the phy is an initiator phy or a target phy implementing the hot-plug timeout timer. State SP2 includes an OUT and a WAIT state machine instruction. An example of state machine instructions for state SP2 is shown below:

SP2: OUT (start hot-plug timeout timer)
SP2_wait: WAIT(Hot-plug timeout timer expires, COMINIT detected)

| Hot-plug timeout | COMINIT detected | |
|---|---|---|
| 1 | 0 | SP0 |
| 0 | 1 | SP4 |
| 1 | 1 | SP4 |
| Default | | SP2_wait |

In state SP2 a hot-plug timeout timer is also started with the OUT state machine instruction. The WAIT state machine instruction is used to monitor the timer. When there is a hot plug timeout prior to detecting a COMINIT detected message, there a state transition to SP0. If a COMINT detected message is received, there is a state transition to SP4. The default state is for state SP2 to re-run the WAIT state machine instruction.

State SP3 waits for a COMINIT transmitted message. State SP3 includes an IF state machine instruction as shown in the example below:
IF <0, COMINIT transmitted> SP4

In state SP3, the IF state machine instruction is used to wait for a parameter to be set. The state machine stays in the same state until the parameter is set. If the COMINIT transmitted message is received, then there is a state transition to state SP4. If not, the state machine remains in state SP3.

Upon entry to state SP4, a transmit COMSAS message is sent. State SP3 waits for receipt of a COMSAS transmitted message and/or a COMSAS detected message. In an embodiment state SP4 includes an OUT state machine instruction and a WAIT state machine instruction, as shown below:

SP4: OUT (transmit COMSAS)
SP4_wait: WAIT(COMSAS detected, COMSAS transmitted)

| COMSAS detected | COMSAS transmitted | |
|---|---|---|
| 1 | 0 | SP5 |
| 1 | 1 | SP6 |
| 0 | 1 | SP7 |
| Default | | SP4_wait |

The OUT state machine instruction results in the COMSAS transmit message being sent. The WAIT state machine instruction waits for receipt of a COMSAS transmitted message or a COMSAS detected message. If a COMSAS detected message is received, the state machine transitions to state SP5. If a COMSAS transmitted and a COMSAS detected message are received, the state machine transitions to state SP6 and if a COMSAS transmitted message is received without a COMSAS detected message, the state machine transitions to state SP7. While a COMSAS transmitted message is not received, the state machine waits in state SP4.

State SP5 waits for receipt of a COMSAS transmitted message. In an embodiment, state SP5 has one IF state machine instruction as shown below:
IF <0, COMSAS transmitted> SP6

In state SP5, the conditional IF state machine instruction waits for receipt of a COMSAS transmitted message. Upon detecting that COMSAS has been transmitted, the state machine transitions to state SP6.

State SP6 waits for a COMSAS completed message, which indicates that COMSAS message has been received. In an embodiment state SP6 has one WAIT state machine instruction as shown below:

SP6_wait: WAIT(COMINIT detected, COMSAS completed)

| COMINIT detected | COMSAS completed | |
|---|---|---|
| 1 | X | SP0 |
| X | 1 | SP8 |
| Default | | SP6_wait |

In state SP6, the state machine waits for a COMSAS completed message. Upon receiving the COMSAS completed message, the state machine transitions to state SP8. Upon receiving a COMINIT detected message, the state machine transitions to state SP0.

Upon entry into state SP7, the COMSAS Detect Timeout time is initialized. Following the above examples, the other states in the OOB state machine shown in FIG. 2 can be translated into state machine instructions.

One advantage of translating states in the state machine into state machine instructions is that multiple sequences of state machine instructions for a particular state may be stored in volatile RAM. The sequence of state machine instructions to be used for a particular state may be selected by selecting the corresponding address in volatile memory such as RAM. For example, multiple versions of state SP0 may be provided by labeling each version with a different suffix, for example, SP0_a, SP0_b, SP0_C. The ability to store multiple versions of routines (set of state machine instructions) for a state is useful in the case that multiple nodes coupled to the serial storage bus operate differently or may operate using different versions of the serial storage protocol. For example, in an embodiment for SAS, the version of the routine for the state that is selected may be based on the SAS address of a remote node. Different sets of state machine instructions may also be provided for different manufacturers of a storage device or based on an Original Equipment Manufacturer (OEM) requirement for example, different OEMs may have different OOB timing requirements.

In an embodiment, the selected version of the state machine instructions to be used for each state may be pre-selected. In another embodiment, the version may be selectable per device based on the result of testing each version on a particular device.

State machine instructions for an embodiment of an OOB sequencer for SAS have been described. These state machine instructions may also be used to execute SATA states for a SATA-based OOB sequencer. The SATA OOB sequence differs from the SAS OOB sequence because instead of exchanging COMSAS and COMINIT OOB signals between the host and target, the target responds with a COMINIT OOB signal upon receiving a COMRESET signal and then the host and target exchange COMWAKE OOB signals. These states may easily be translated into sequencer micro-firmware using similar state machine instructions to those described above for a SAS OOB sequence.

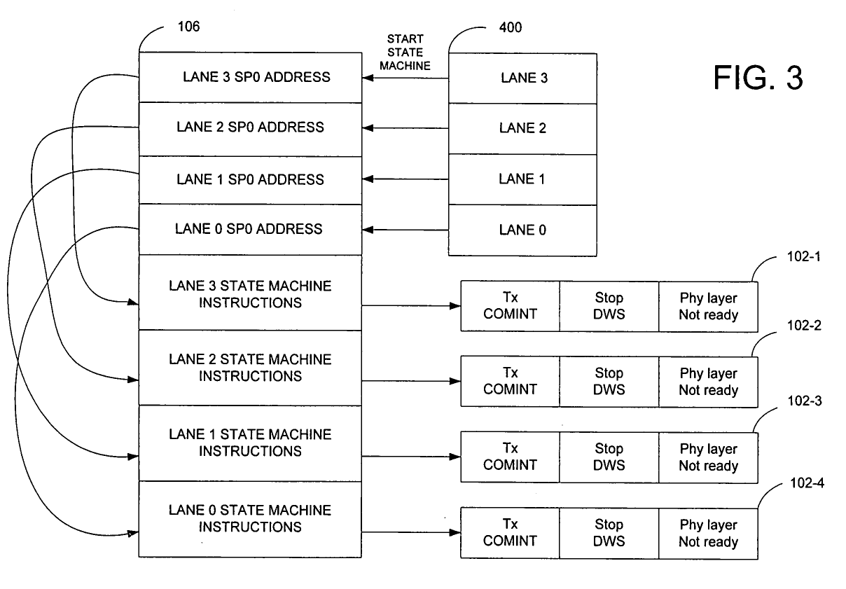

FIG. 3 is a block diagram of an embodiment of the hardware engine 100 shown in FIG. 1. The hardware engine 100 includes an engine per SAS lane (link). In the embodiment shown, there are four lane engines 400, one for each of four lanes (lane 0-3). The volatile memory 106 stores state machine instructions for lanes 0-3. The lane engines 400 may share the same instruction memory and/or the same state machine instruction routine. In another embodiment, there is one lane engine which is time shared to handle all of the links (SAS lanes).

On power up, all of the lane engines 400 may be disabled and wait to be enabled. After an engine is enabled, the engine starts a respective OOB state machine by retrieving an address for state SP0 for the respective lane from the volatile memory 106 and using the retrieved address to jump to state SP0. The first instruction for state SP0 is then retrieved by the respective lane engine.

The hardware engine 100 also includes a respective status register 102-1, . . . , 102-4 for each lane in registers 102. Each status register is capable of storing outputs that are used by the state machine instructions. In the embodiment shown, each status register 102-1, . . . , 102-4 stores the “transmit COMINT”, “stop DWS” and “phy layer not ready” outputs. In other embodiments, other outputs may be stored in the status registers.

As discussed earlier in conjunction with FIG. 2, the state machine instructions stored in non-volatile memory are used in conjunction with the registers 102 to implement the state machine shown in FIG. 2. For example, a start state machine request received from the lane 0 engine results in retrieving the state SP0 address for lane 0 which stores the start address for state SP0 for lane 0 in the volatile memory 106.

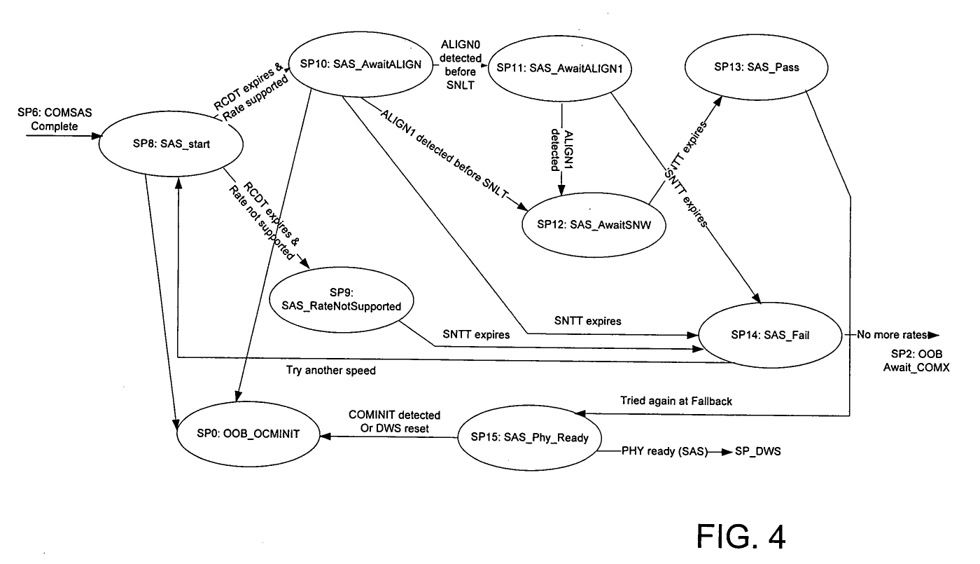

FIG. 4 is a state machine diagram that illustrates SAS speed negotiation states in the phy reset sequence. State machine instructions for the SAS speed negotiation states may be stored in the volatile memory 106 using the instructions already discussed in conjunction with FIG. 2. As shown in FIG. 2, SAS speed negotiation state SP8 is entered from state SP6 (FIG. 2) and SAS speed negotiation state SP16 is entered from state SP7 (FIG. 2).

Each of the SAS speed negotiation states SP8-SP15 may be encoded using the WAIT, OUT, IF and similar state machine instructions and stored in the volatile memory 106. Additional arguments are defined for transmit classes, inputs start/stop and set/clear class instructions. For example, additional arguments are defined for timers used for speed negotiation such as Rate Change Delay Time (RCDT) timer, Speed Negotiation Transmit Time (SNTT) timer, and Speed Negotiation Lock Time (SNLT) timer. The states associated with the SAS speed negotiation sequence are described in the SAS standard.

An embodiment of the invention has been described for implementing state machines for the phy reset sequence and speed negotiation sequence for the SAS protocols. However, the invention is not limited to SAS. An embodiment of the invention may also be used to handle the phy reset sequence and speed negotiation sequence for the SATA protocol, Fibre Channel Arbitrated Loop (FCAL) protocol or similar protocols. A version of the Fibre Channel (FC) standard is described in the American National Standards Institute (ANSI) Standard Fibre Channel Physical and Signaling Interface-2 (FC-FS-2) Aug. 9, 2005 Specification.

It will be apparent to those of ordinary skill in the art that methods involved in embodiments of the present invention may be embodied in a computer program product that includes a computer usable medium. For example, such a computer usable medium may consist of a read only memory device, such as a Compact Disk Read Only Memory (CD ROM) disk or conventional ROM devices, or a computer diskette, having a computer readable program code stored thereon.

While embodiments of the invention have been particularly shown and described with references to embodiments thereof, it will be understood by those skilled in the art that various changes in form and details may be made therein without departing from the scope of embodiments of the invention encompassed by the appended claims.

1. An apparatus comprising:
a non-volatile memory to store state machine instructions; and
a hardware engine, the hardware engine including volatile memory to store the state machine instructions and a microsequencer, the microsequencer executing the state machine instructions to perform a phy layer function.

2. The apparatus of claim 1, wherein the state machine instructions are loaded into the volatile memory from the non-volatile memory and accessed from the non-volatile memory by the microsequencer.

3. The apparatus of claim 1, wherein a phy reset Out of Band (OOB) sequence is encoded in the state machine instructions.

4. The apparatus of claim 1, wherein a phy speed negotiation sequence is encoded in the state machine instructions.

5. The apparatus of claim 3, wherein the phy reset OOB sequence is a Serial Advanced Technology Attachment (SATA) phy reset OOB sequence.

6. The apparatus of claim 3, wherein the phy reset OOB sequence is a Serial Attached Small Computer Systems Interface (SAS) phy reset OOB sequence.

7. The apparatus of claim 1, wherein the state machine instructions include a state machine instruction that results in setting an output.

8. The apparatus of claim 1, wherein the state machine instructions include a state machine instruction to detect a branching condition.

9. The apparatus of claim 1, wherein the state machine instructions include a state machine instruction to detect that a parameter is set.

10. The apparatus of claim 1, wherein the state machine instructions include a plurality of sequences of state machine instructions for a state, a sequence of state machine instructions for the state selectable based on a version of a serial storage protocol, a manufacturer of a storage device or an Original Equipment Manufacturer (OEM) requirement.

11. A method comprising:
storing state machine instructions in a non-volatile memory; and
performing, by a microsequencer in a hardware engine, a phy layer function by executing the state machine instructions.

12. The method of claim 11, further comprising:
loading the state machine instructions into a volatile memory in the hardware engine from the non-volatile memory; and
accessing, by the microsequencer, the state machine instructions from the non-volatile memory.

13. The method of claim 11, wherein a phy reset Out of Band (OOB) sequence is encoded in the state machine instructions.

14. The method of claim 11, wherein a phy speed negotiation sequence is encoded in the state machine instructions.

15. The method of claim 13, wherein the phy reset OOB sequence is a Serial Advanced Technology Attachment (SATA) phy reset OOB sequence.

16. The method of claim 13, wherein the phy reset OOB sequence is a Serial Attached Small Computer Systems Interface (SAS)phy reset OOB sequence.

17. The method of claim 11, wherein the state machine instructions include a state machine instruction that results in setting an output.

18. The method of claim 11, wherein the state machine instructions include a state machine instruction to detect a branching condition.

19. The method of claim 11, wherein the state machine instructions include a state machine instruction to detect a parameter is set.

20. The method of claim 11, wherein the state machine instructions include a plurality of sequences of state machine instructions for a state, a sequence of state machine instructions for the state selectable based on a version of a serial storage protocol, a manufacturer of a storage device or an Original Equipment Manufacturer (OEM) requirement.

21. An article including a machine-accessible medium having associated information, wherein the information, when accessed, results in a machine performing:
storing state machine instructions in a non-volatile memory; and
performing, by a microsequencer in a hardware engine, a phy layer function by executing the state machine instructions.

22. The article of claim 21, wherein a phy reset Out of Band (OOB) sequence is encoded in the state machine instructions.

23. The article of claim 21, wherein a phy speed negotiation sequence is encoded in the state machine instructions.

24. A system comprising:
a disk drive;
a non-volatile memory to store state machine instructions; and
a hardware engine coupled to the disk drive, the hardware engine including volatile memory to store state machine instructions and a microsequencer, the microsequencer executing the state machine instructions to manage initialization of a serial protocol for use in communicating with the disk drive.

25. The system of claim 24, wherein a phy reset Out of Band (OOB) sequence is encoded in the state machine instructions.

26. The system of claim 24, wherein a phy speed negotiation sequence is encoded in the state machine instructions.
